(19) United States
(12) Patent Application Publication
(10) Pub. No.: US 2016/0135386 A1
(43) Pub. Date: May 19, 2016

(54) PLANT GROWTH SUPPORT POT

(71) Applicant: Thomas Victor Merz, Scarborough (CA)

(72) Inventor: Thomas Victor Merz, Scarborough (CA)

(21) Appl. No.: 14/547,441

(22) Filed: Nov. 19, 2014

(51) Int. Cl. A01G 9/12; A01G 13/00

(52) U.S. Cl. CPC A01G 9/124; A01G 9/12; A01G 13/00

(57) ABSTRACT

A plant growth support pot having a support structure to enhance growth in a desired line, said support pot comprising of a pot, wherein said pot has a pot-height, a pot-collar, a pot-bottom, a pot-side-wall and a pot-top; an insert, wherein said insert has an insert-height, an insert-collar, an insert-bottom, an insert-side-wall and an insert-top, wherein said insert-height being shorter than said pot-height; said insert being inserted into the pot, wherein said insert-collar coincides with said pot-collar; a plurality of pillar members each having a distal, a medial and a proximal end; said pot-bottom comprising of a plurality of receiving holes to receive said distal end of said pillar members; and said insert-bottom comprising of a plurality of insert-aperture to receive said medial section of said pillar members.

### FIELD OF THE INVENTION

The present invention relates generally to plant support devices, and specifically to a plant growth support pot in which the support structure is built into the plant pot and the support structure comprises of pillars positioned in a plurality of pillar holders embedded the pot.

### BACKGROUND OF THE INVENTION

Plant and flower pots have always been used for aesthetic and functional reasons. Plants add beauty to indoor and outdoor locations and are very important for the environment. Growing and cultivating plants has been done in different ranges from fruit orchards, vegetables, to long plants. One of the most important factors for improving plant growth is allowing it to grow straight. Moreover gardeners, nurseries and garden centers have a strong incentive to introduce and sell their products in a healthy condition. They would have always been pleased to present the customer a plant that stands straight. Every experienced gardener should know the size of the pot to use and anticipate how big the plant will become. A gardener also knows that at a certain times plants, trees, and vegetables need to be supported during various stages of their growth process.

According to these aspects, methods to give plants, especially newly planted plants, a support structure to keep them in an upright position during the growth stages are highly desirable.

There are a variety of plant growth support systems. Most of them have a base which is placed inside a flower pot and a support pole that is vertically extended from the base and irregularly mounted thereto so that the plant grows straight from the center of the flower pot. Some other plant support systems comprise a base and a tubular member attached to the base, along with a shaft positioned inside the base and a locking strap to secure the plant. In these kinds of systems, the plant support or stake is disposed centrally of the plant pot and therefore constitutes an obstruction to the proper central positioning of the plant within the plant pot.

There are also self-positioning plant support devices, which have a rod like plant support which is held in a plant pot adjacent to its side walls. The holder is a base plate with an integral socket upstanding from a central portion thereof and the rod engages into and stands up from the socket. In these kinds of plant pots the support system is on one side and there is not a sufficient support for the plant during its growing stages.

In another invention there is described a plant support which is integral with a base plate. The plant support extending through a central hole of the plant pot and the base plate sandwiched between the bottom of the plant pot and the saucer. There are shown plant supports having holders inserted within the plant pot directly which occupy an extensive space for growth of the plant roots. The soil in the pot when being watered becomes more fluid and the holder stakes can easily be toppled and do not properly support the plant.

These devises may be suitable for particular purpose, but they are not as suitable for supporting a plant in an upright position in various type of soil and various types of plants. Thus there remains a need for plant-growth-support-pot for potted plant such that the pot itself provides an adequate support system for the plant.

### SUMMARY OF THE INVENTION

The present invention is a pot having a support structure to enhance growth in a desired manner, referred to as a “plant-growth-support-pot.” The present pot comprises of a first-pot and a second-pot, wherein said first pot having a first-bottom, a first side-wall and a first-top collar. Said second-pot, wherein having a second-bottom, a second-side wall and a second-top collar. The second-side wall is shorted than the first-side wall. The second-pot being inserted into the first-pot, and said second-top collar sits on the top of said first-top collar, wherein said second-top collar coincides with said first-top collar. The support structure comprising of a plurality of pillar members, having a distal, a medial and a proximal end. Said first-pot having a first-bottom and second-pot having a second-bottom. Said first-bottom has a plurality of receiving holes to receive the distal end of supporting pillars. Second-bottom further is having plurality of receiving apertures to receive medial end of the supporting pillar. The plant growth support pot is designed, so that the support structure which are the pillars, are supported prolongation the plant pot and stand in a closest distance of the plant to give sufficient support to plant and encourage any type of plant to grow straight and tall. This pot can be easily used by homeowners as well as professional gardeners, nurseries and wherever plants are growing.

The first-bottom also having at least four drain holes, which is positioned in the outer perimeter of the said bottom. The second-pot having second-bottom being a semi-hollow-shape with an inwardly extended ledge. Said bottom ledge having a plurality of apertures. Said apertures being aligned with said pillar receiving holes of first-bottom to support any pillar, extending from said first-bottom upward. First top having posts on the top rim and second-top having pins protruding underneath the collar. Once the second-pot is inserted into the first-pot, the pins of the second pot sit on the holes of the first pot. This will hold pots in a fixed position and aligned such that the receiving holes in first-bottom and second-bottom stand aligned. The pillars are fixed in the receiving holes of the firs-bottom and extended to the pillar receiving apertures on the second-bottom. The number of support pillars is depended on the type and size of the plant. Thereon the pot is filled with dirt and a plant is planted. The supporting pillars in this supporting system allow the plant, especially young plants to grow straight and tall.

The first objective of the plant-growth-support-pot is to provide a strong support system by protecting each pillar with a second hole closer to the top section of the pot.

Another objective of the present invention is having much deeper and narrower pot shape to allow the roots to grow longer and healthier.

More support system can be provided by adding four horizontal rods preferably every 6 inches which can control the plant growth process. Support system can be more secured by inserting notches on rods and using plurality of strips to secure the rods in designated place.

Another objective of the present invention is to provide a support system which is supported all along the pot from bottom to the top and all through and in the closest distance to the plant.

Another objective of the present invention is greatly enhancing the strength of the support structure by having a double side in the side wall of the pot.

Another objective of the present invention is to provide a support structure that keeps the original outer shape of the pot.

Another objective of the present invention is to improve the disadvantages in the prior art by using a secure support system for pillars instead of using extension ends to interfit pillars.

Another objective of the present invention is that the pot and the pillars are made out of 100% recyclable materials, which reduces landfill waste.

Another objective of the present invention is to provide a pot with support system that can easily stack on top of each other to make storage easier

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments hereinafter be described in conjunction with the appended drawings provided to illustrate and not to limit the scope of the claims, wherein like designations donate like elements, and in which:

FIG. 1 (a-e) is a perspective view of the first-pot showing the receiving holes and the receiving posts of the present invention;

FIG. 2 (a) shows a top plan view of the second-pot, (b) and (c) are perspective top view of second-pot the receiving holes of said pot;

FIG. 3 (a-b) again is a perspective view of the first-pot and the second-pot of the plant-growth-support-pot;

FIG. 4 shows a perspective side view of the first-pot and second-pot assembled together;

FIG. 5 (a) shows a side view of the plant-growth-support-pot and (b) shows a perspective top view of said pot;

FIG. 6 (a-b) shows a perspective top view of the plant-growth-support-pot showing the pillars inserted into the holes; and

FIG. 7 (a-b) is a perspective top view of the plant-growth-support-pot after assembly.

### DETAILED DESCRIPTION OF THE DRAWINGS

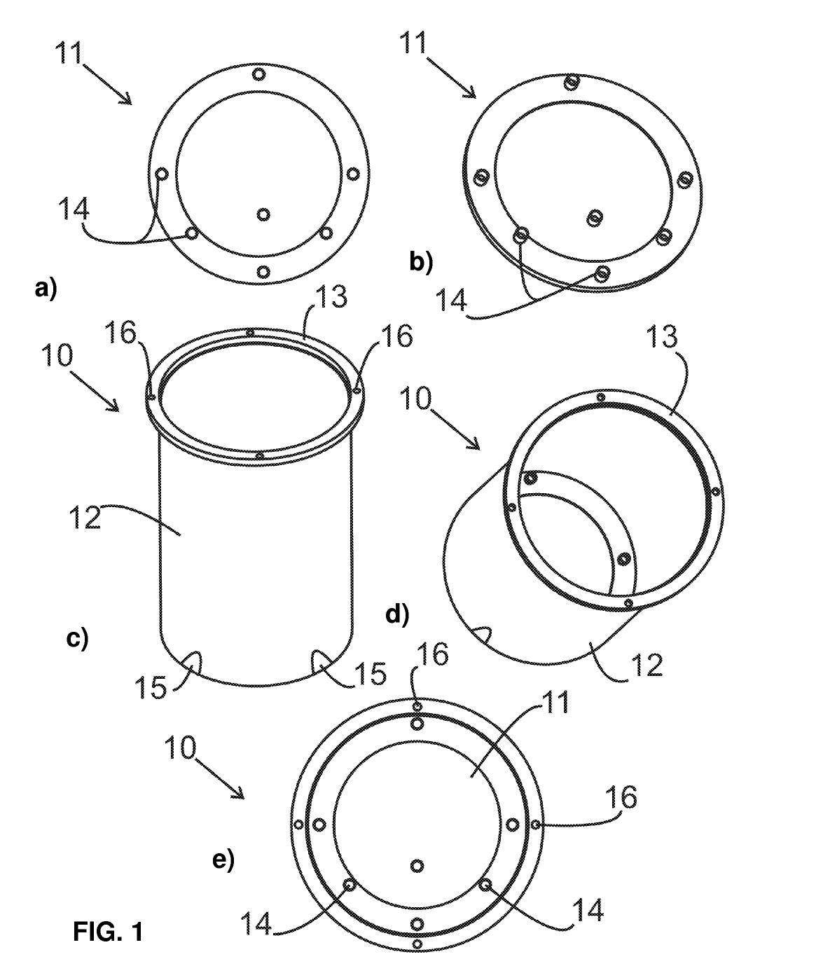

In FIG. 1, a first-pot 10 which is a cylindrical plant pot is shown. The first-pot 10 is designed deeper and narrower allowing the roots of the plant to grow longer and healthier. Wherein said first-pot 10 comprises of a first-bottom 11 a first-side wall 12 and a first-top collar 13. The plant pot can be any suitable material, which is well known in the art preferably the plant pot is made of a plastic polymer material like polypropylene that can be easily manufactured such as by injection moulding and is also recyclable.

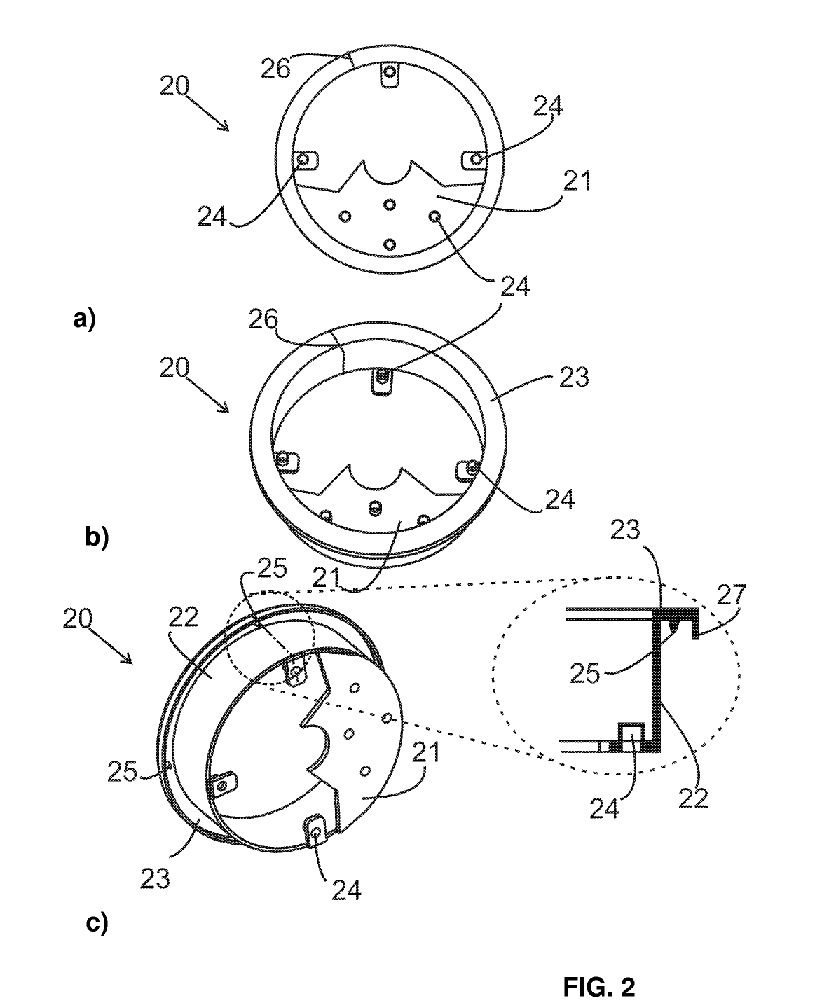

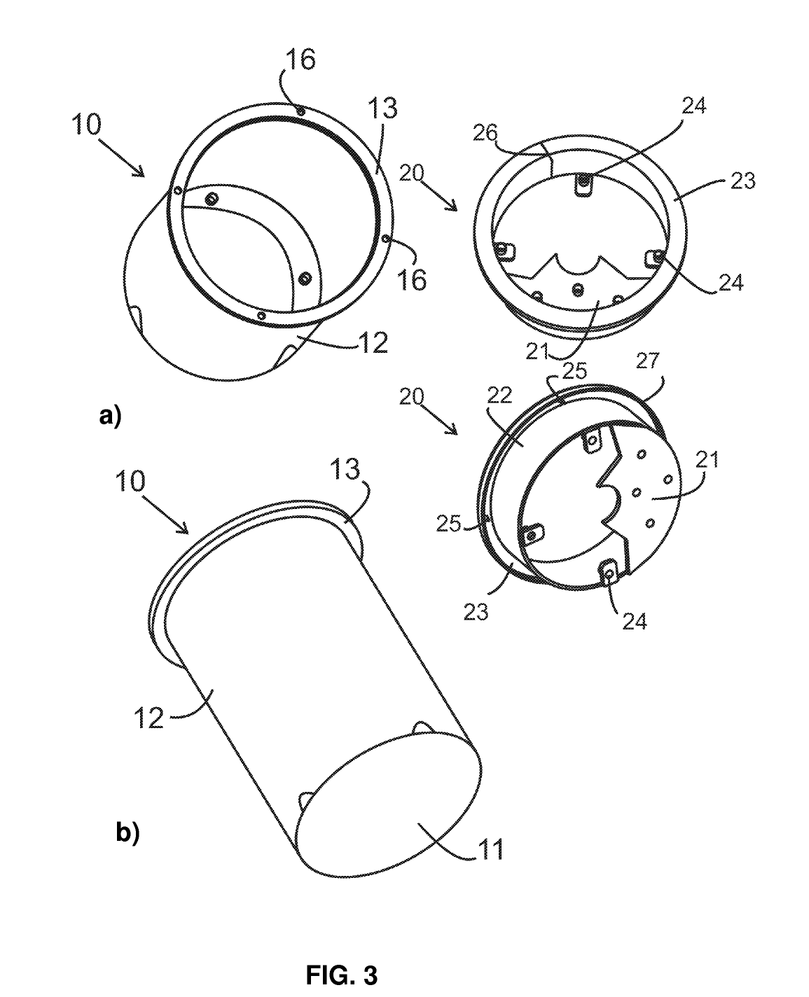

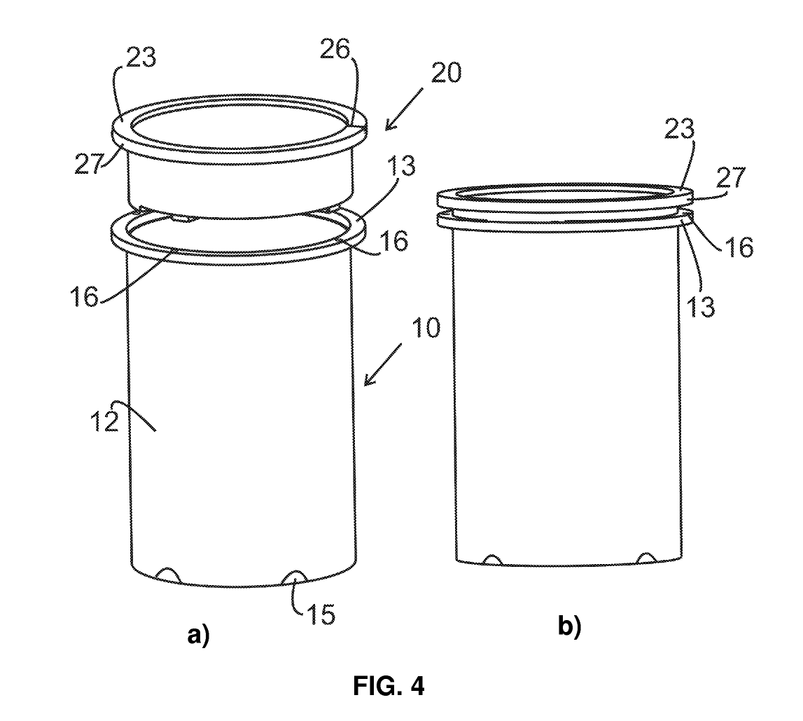

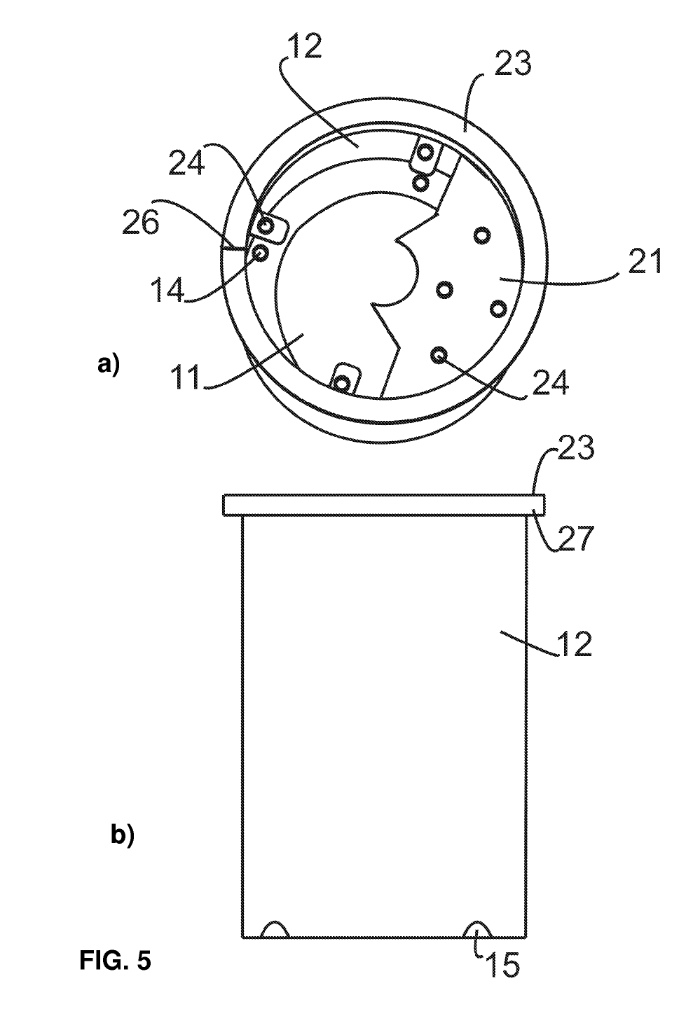

In FIG. 2, a second-pot 20 is a cylindrical pot with a semi hollow bottom 21. Referring to FIG. 3, FIG. 4, and FIG. 5, the second pot 20 comprises of a pot having lower height than the first-pot 10 and lower second-side wall 22.

As shown in FIG. 1, first-bottom 11 of the first-pot 10 is moulded with an specific thickness to create holes thereon. Said first-bottom having seven receiving holes 14 to hold elongated, rigid rod-like pillars 30. Said receiving holes 14 having support material as known in the art on either side of the hole to support the pillars 30. According to FIG. 1, said receiving holes 14 on first-bottom 11 have a specific arrangement. The support system strongly relates to this arrangement to allow the plant to grow in the direction of the secured rod.

Again as shown in FIG. 1, the first-bottom-wall 12 comprises of 4 drain holes 15. As shown again in FIG. 1, the first-top-collar 13 having an edge with 4 receiving posts 16, to fix the second-pot 20 thereon.

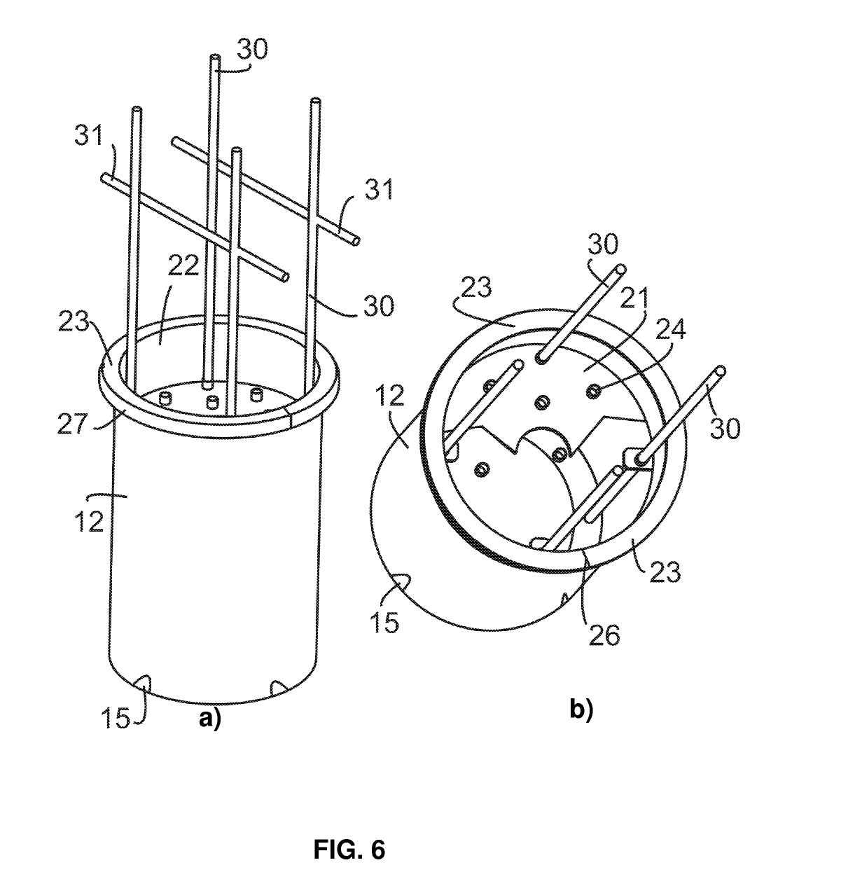

As shown in FIG. 1(b) the hole members 14 are integrally mounted to first-bottom 11. Referring to FIG. 6 the inner diameter and size of the hole members 14 should be complementary to the outer diameter of the pillars 30 and having different inner diameters for engagement therein by plant support pillars 30 of varying external diameters. For added security, the pillars 30 can be fixed by pins in the bottom. Pillars 30 are polypropylene rods, which have an excellent corrosion resistance, and are strong and rigid. Polypropylene can be cut easily, drilled with a regular metal bit to reach the desired height. This can reduce the use of other raw materials like wood, bamboo and steel to be dumped in landfills.

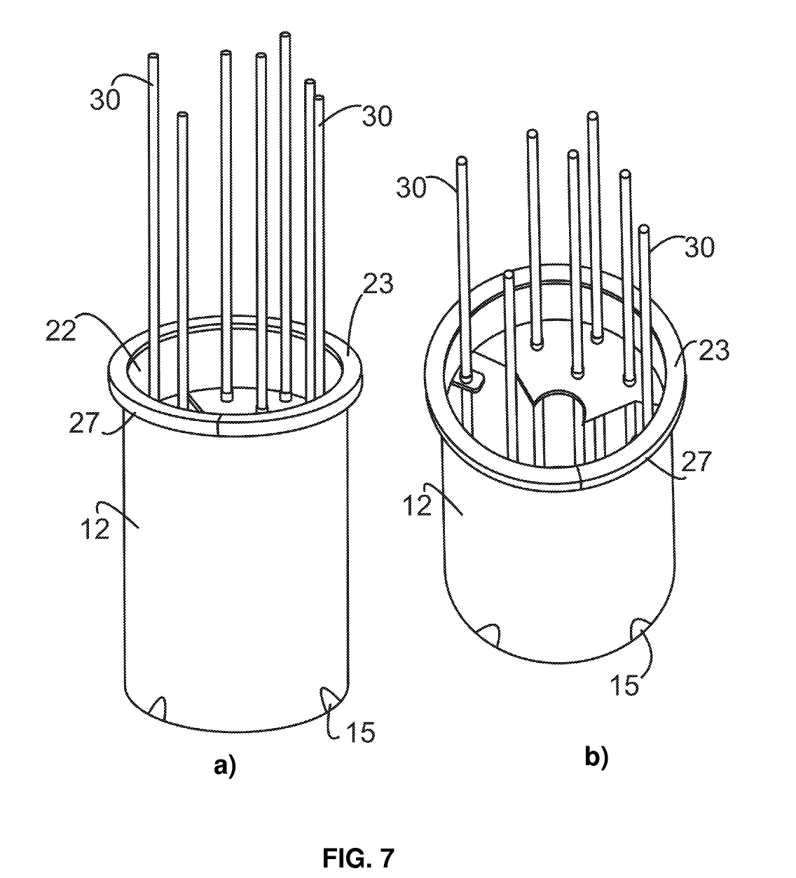

As shown in FIG. 6-7, support pillars 30 after being fixed in the hole members 14 on the first-bottom 11 of the plant-growth-support-pot elongate and extend to the apertures 24 on the second-bottom 21 of the plant pot. Supporting pillars 30 extend through the upper hole members 24 upwardly. This increases the structural support system and prevents pillars from bending under transverse force exerted by the plant.

FIG. 2 shows the second-pot 20 of the plan-growth-support-pot. As described the second pot 20 is a cylindrical cover-like-pot, comprising of a second-bottom 21, second-wall 22 and second-top collar 23 which is formed with a lower diameter as shown in FIG. 3 to sit on the first pot 10. The difference in diameter size between the first-pot 10 and the second-pot 20, is very low, so that whenever the second-pot 20 inserts into the first-pot 10, the second-wall 22 is tangent to the first-wall 12. According to FIG. 2, the second-wall 22 has a side vertically cut 26 along its height. Whenever there is a need to remove the plant from the said pot to plant in another place, the second-pot can be removed through said cut 26, without any damage to the plant. A pin member (not shown in the drawings) is inserted into said cut 26 to keep open edges of said cut 26 firmly in place. With reference to FIG. 3, the second-top 23 having an L-shape edge 27 externally extended to the second wall 22 from longer part. Four fixing pins 25 are mounted on the inner surface of the said second-top 23. According to FIG. 3(a-b) FIG. 4(a-b) the second-pot 20 is inserted into first-pot 10 and the engagement of the fixing pins 25 and receiving posts 16 can greatly fix two parts in a desired position. There is also support material on either side of each hole to support the pins. Once the second-pot 20 is inserted into the first-pot, said pins and support materials are covered by L-shape edge 27.

According to FIG. 2-4, the second-pot 20 has a second-bottom 21. The second-bottom 21 having a semi hollow shape with a sufficient thickness. There are 7 receiving apertures 24 symmetry to the first-bottom 21. The arrangement of said receiving apertures 24 on second-bottom 21 as shown in FIG. 2 (a-c) is the same on first-bottom. The semi hollow shape of the second-bottom 21, provides an additional support by providing enough space to reach the plant whenever needed and to hold the plant grow in the direction of secured rods.

With reference to the FIG. 3, after the second pot inserted into the first-pot, the double sided wall in upper portion of the plant growth support pot provides an additional support to the plant growth support pot.

FIG. 6, FIG. 7 is a perspective view of the present invention after the support pillars 30 are inserted. According to FIG. 6 (b), receiving holes 14 on first-bottom 11 and receiving apertures 24 on second bottom 21 of the plant growth support pot should be in same direction and that is easily adjustable. After the pillars are inserted and fixed into the first bottom 11 receiving holes 14, the first-pot 10 will be filled with soil and the plant is inserted into the soil. The second-pot 20 is inserted through the receiving apertures 24 on second bottom 21 and in the same direction and sits on the first-pot. With reference to FIG. 3, fixing pins 25 are inserted into the receiving posts 16.

Some plants may require more support as they grow taller. According to FIG. 6 (a), to increase the rigidity of the support structure, more supporting rods 31 can be connected and secured horizontally or vertically to the support structure at a desired distance. The rods can comprise any suitable material, but it is desired to be the same as vertical support pillars. Securing can be through any suitable type of structure or device like plastic ties that is known in the art.

Another embodiment of the present invention is to have support system which can be more secured by inserting notches on rods and using plurality of strips to secure the rods in designated place.

Another embodiment of the present invention is to have a separate plate-like insert bottom, sized to said pot-bottom comprising of plurality of receiving holes to receive distal end of pillar members. Said Plate could be inserted in any pot.

The forgoing is considered as illustrative only of the principles of the invention. Further, since numerous modification and changes will readily occur to those skilled in the art, it is not desired to limit the invention to the exact construction an operation shown and described, and accordingly, all suitable modifications and equivalents may be resorted to, filling within the scope of the invention.

With respect to the above description, it is to be realized that the optimum relationship for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1- A plant growth support pot having a support structure to enhance growth in a desired manner, said support pot comprising:
a. A first-pot, wherein said first-pot having a first-bottom, a first-side wall and a first-top collar;
b. A second-pot, wherein said second-pot having a second-bottom, a second-side wall and a second-top collar, wherein said second-side wall being shorter than said first-side wall;
c. said second-pot being inserted into the first-pot, wherein said second-top collar coincides with said first-top collar;
d. a plurality of pillar members each having a distal, a medial and a proximal end;
e. said first-bottom comprising of a plurality of receiving holes to receive said distal end of said pillar members; and
f. said second-bottom comprising of a plurality of apertures to receive said medial section of said pillar members.

2- The plant growth support pot of claim 1, wherein said pot further having a plurality of drain holes designed on an outer perimeter of said first-bottom.

3- The plant growth support pot of claim 1, wherein said second-bottom being a semi-hollow-shape having an inwardly extended ledge, wherein said ledge having a plurality of apertures to receive said medial end of said pillar member, wherein said receiving holes of first-bottom being aligned with said-apertures.

4- The plant growth support pot of claim 1, wherein said first-top collar having a plurality of posts and said second-top collar having a plurality of pins, wherein said pins being aligned to be inserted into said posts, whereby said first-pot and said second-pot become firmly attached.

5- The plant growth support pot of claim 1, wherein said second-pot further having a cut on the second-wall, whereby said second-pot may be removed from a plant through said cut without damaging the plant, said cut further having a pin to keep edges of said cut firmly in place

6- The plant growth support pot of claim 1, further having a plurality of horizontally aligned support rods being attached to said pillars to stand in a higher elevation of the top of the pot.

7- The plant growth support pot of claim 1, wherein materials of said first pot, said second pot and said pillars being selected from the group of metals, plastics and wood.

8- The plant growth support pot of claim 1, wherein materials of said pillars preferably being polypropylene.

9- A plant growth support pot having a support structure to enhance growth in a desired manner, said support pot comprising:
a. a first-pot, wherein said first pot has a first-bottom, a first-top collar and a pot-side-wall;
b. a second-pot wherein said second-pot has a second-bottom, a second-side wall and a second-top collar, wherein said second-side wall being shorter than said first-top collar;
c. said second-pot being inserted into the first-pot, wherein said second-top collar coincides with said first-pot collar;
d. a plurality of pillar members each having a distal, a medial and a proximal end;
e. an insert, wherein said insert being a plate sized to said first-bottom, said insert comprising of a plurality of receiving holes to receive said distal end of said pillar members;
f. a second-bottom comprising of a plurality of apertures to receive said medial section of said pillar members.

10- The plant growth support pot of claim 9, wherein said pot further having a plurality of drain holes designed on an outer perimeter of said pot-bottom.

11- The plant growth support pot of claim 9, wherein said second-bottom being a semi-hollow-shape having an inwardly extended ledge, wherein said ledge having a plurality of apertures to receive said medial end of said pillar member, wherein said apertures of said second-pot being aligned with said insert holes.

12- The plant growth support pot of claim 9, wherein said first-top collar having a plurality of posts and said second-top collar having a plurality of collar-pins, wherein said collar-pins being aligned to be inserted into said posts, whereby said first-pot and said second-pot become firmly attached.

13- The plant growth support pot of claim 9, wherein said second-pot further having a cut on the second-wall, whereby said second-pot may be removed from a plant through said cut without damaging the plant, said cut further having a pin to keep edges of said cut firmly in place

14- The plant growth support pot of claim 9, further having a plurality of horizontally aligned support rods being attached to said pillars to stand in a higher elevation of the top of the pot.

15- The plant growth support pot of claim 9, wherein materials of said first-pot, said second-pot, said insert and said pillars being selected from the group of metals, plastics and wood.

16- The plant growth support pot of claim 9, wherein materials of said pillars preferably being polypropylene.
